(19) United States
(12) Patent Application Publication
(10) Pub. No.: US 2002/0128014 A1
(43) Pub. Date: Sep. 12, 2002

(54) Method and apparatus for maintaining traffic capacity in a wireless communication system including automatic frequency allocation (AFA)

(76) Inventor: Dayong Chen, Cary, NC (US)

Correspondence Address: MOORE & VAN ALLEN, PLLC, 2200 W MAIN STREET, SUITE 800, DURHAM, NC, 27705, US

(21) Appl. No.: 09/803,289

(22) Filed: Mar. 9, 2001

(51) Int. Cl. H04Q 7/20

(52) U.S. Cl. 455/447; 455/450; 455/452; 455/455

(57) ABSTRACT

Method and apparatus for maintaining traffic capacity in a wireless communication system including automatic frequency allocation. An automatic frequency allocation process, which removes frequencies subject to interference, is enhanced by providing an early reestablishment process that automatically determines if the allocated set of frequencies becomes too small to handle offered traffic. In this event, the new process reallocates some of the “interfered” frequencies to the allocated set, accepting a slightly increased risk of problem interference in return for having enough frequencies to meet demand. The reallocation is based on measured interference levels and a current residual penalty time for each frequency. In one embodiment, the invention is implemented in a small-scale, wireless communication system having a programmable radio exchange and one or more transceivers. Such systems are often used for wireless office communication systems, or for picocell systems which are part of a public cellular telephone network.

### BACKGROUND OF THE INVENTION

1. Field of the Invention

This invention relates to small wireless communication systems such as wireless office systems and picocell extensions of the public cellular communication network. More particularly, this invention relates to automatic frequency allocation (AFA) within such small wireless communication systems.

2. Description of the Problem Solved

A public wireless communication system, in the form of a cellular system, is designed to cover a large geographic area. The system is divided into numerous cells providing air interface between mobile stations and land-based systems. Each cell includes a base station for communicating with mobile stations. These wireless communication systems maintain a set of frequencies that are used for traffic channels and control channels. Frequency planning is necessary in order to determine which of the frequencies should be used at any given time.

Cellular based system design is often used as a foundation for smaller, usually indoor systems, such as wireless office systems (WOS), and “picocell” extensions to the public cellular network. These smaller systems may share the spectrum with wide-area cellular systems, also referred to as outdoor systems. Being smaller in scale, the smaller systems use less extensive processing systems and lower powered transceivers in radio heads for communicating in a localized area. Cellular system frequency planning schemes are often not suitable for the smaller wireless systems. Frequencies are not assigned to a transceiver or radio head. Instead frequencies are allocated as a pooled resource common for all transceivers.

Frequency planning for such a small system has to take into consideration several conflicting goals. These include that the system should not disturb external systems, the system should always have available operating frequencies relatively free from outside interference, and operation and maintenance should be simple and inexpensive.

Adaptive frequency allocation (AFA) is a dynamic channel allocation scheme that automatically finds and maintains a pool of least interfered frequencies, called allocated frequencies, that can immediately be assigned both as control and traffic channels as transceivers register to use a small wireless system. AFA accomplishes this task by evaluating, in real-time, frequencies in the entire frequency band that the system operates on. A particularly elegant and useful AFA system and method is described in co-pending U.S. patent application Ser. No. 09/322,623 entitled, “Automatic Frequency Allocation (AFA) for Wireless Office Systems Sharing the Spectrum with Public Systems,” filed May 28, 1999, which is assigned to the assignee of the present application, and which is incorporated herein by reference.

The above-referenced AFA uses dedicated radio scanners placed in different locations of the building to periodically measure the radio signal strength (RSS) on all frequencies. The AFA algorithm disclosed in the above-referenced application consists of two processes. The removal process removes the frequencies from the set of allocated frequencies based on an interference level derived from the RSS and the reestablishment process reestablishes frequencies that are currently not allocated when interference has subsided and a penalty time for a frequency has passed. In order to remove the interfered frequencies as soon as possible and to make the allocated frequencies stable, the removal process is executed much more frequently than the reestablishment process. As shown in FIG. 1, the time duration between two consecutive removal processes, called a removal period is much smaller than the time duration between two reestablishment processes, called a reestablishment period. In other words, the reestablish period is much longer than the removal period.

A problem can occur with the above-described AFA scheme in that it is possible to have too few allocated frequencies in a high interference environment, especially when the AFA parameters are set such that interference thresholds are low, penalty times are long, and the reestablishment period is very long compared to the removal period. FIG. 2 shows a possible variation of the size of the allocated set as removal and reestablishment processes are executed. Note that with each removal, 204, the number of allocated frequencies illustrated by curve 201 either decreases or remains unchanged. In this example, the number of allocated frequencies is below the minimum desired traffic capacity, 202, most of the time within a reestablishment period, ending at 203, because frequencies are removed much more frequently than reestablished. It would be very advantageous to be able to use some of these “interfered” frequencies immediately in the case where the number of allocated frequencies becomes too low to handle the offered traffic.

### BRIEF SUMMARY OF THE INVENTION

The present invention solves the above-described problem by providing an “emergency” reestablishment process that automatically determines if the allocated set of frequencies becomes too small to handle offered traffic. In this event, the new process reallocates some of the “interfered” frequencies to the allocated set, accepting a slightly increased risk of having a slightly higher interference in return for having enough frequencies to meet traffic demand. If the size of the allocated set never drops below the critical level, the frequencies are reestablished in the same course as in the previous AFA that did not include the invention, thus ensuring that interference to traffic in the small wireless system is minimized to the greatest extent possible when capacity is not a problem.

According to one embodiment of the invention, previously removed frequencies can be reallocated as often as each removal interval to be used as allocated frequencies in order to maintain traffic capacity in a wireless communication system operable for automatic frequency allocation. Each removed frequency has an associated penalty time and interference level. At each normal removal interval of the AFA, a determination is made as to whether the number of allocated frequencies is less than a minimum number of allocated frequencies required to maintain traffic capacity. A “proposed group” frequencies having the lowest acceptable interference levels from among all available frequencies is selected by first sorting available frequencies by interference level to obtain a starting group. The proposed group is then formed by selecting only frequencies from the starting group whose interference level is below a maximum acceptable level. The final group of frequencies that can or should be reallocated is arrived at by selecting frequencies from the proposed group that have the shortest acceptable penalty time. This selection is accomplished by sorting according to current penalty time to obtain an intermediate group of frequencies, and then selecting from the intermediate group only frequencies whose penalty time is less than a maximum acceptable penalty time. Finally, all frequencies in the final group of frequencies, which are not already allocated, are reallocated immediately.

It should be noted that the early or emergency reestablishment procedure of the invention is often referred to herein as a “reallocation” procedure, merely to clearly distinguish it from the normal reestablishment procedure, which was known in the existing algorithm. It should also be noted that the terminology being used to refer to groups of frequencies such as, “proposed group”, “intermediate group”, “final group”, etc. as well as any mathematical variables used to refer to groups, sets, or numbers of frequencies, interference levels, or time periods is arbitrarily selected for discussion purposes, and has no bearing on the scope of the claimed invention.

In one embodiment, the invention is implemented in a small-scale, wireless communication system having a programmable radio exchange and one or more transceivers. The radio exchange includes a processing system and many of the functions are implemented via computer program code or instructions installed in the radio exchange. The radio exchange in this embodiment includes a radio control unit that is connected to one or more scanners for measuring received signal strength (RSS) on one or more frequencies. The radio control unit derives an interference sample for each frequency measured by the scanner or scanners. The radio exchange also includes a reallocation process (implemented as computer code and processing hardware and logic) that determines if a number of allocated frequencies is less than a minimum number of allocated frequencies required to maintain traffic capacity. The process reallocates frequencies based on current penalty times and interference levels if and when the number of allocated frequencies is less than the minimum number.

### BRIEF DESCRIPTION OF THE DRAWINGS

FIG. 1 illustrates the relative length of the removal and reestablishment periods in an AFA system of the prior art.

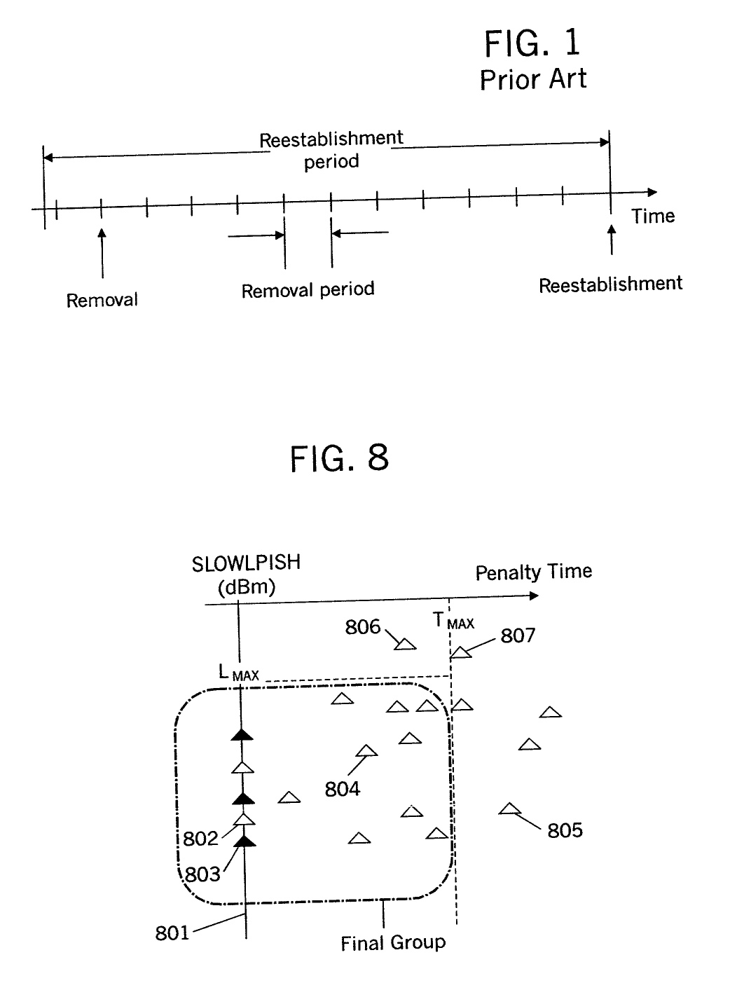

FIG. 2 is a graph of the number of allocated frequencies over time during normal removal and reestablishment procedures in an AFA system of the prior art.

FIG. 3 is a network diagram, which illustrates the operating environment of the present invention.

FIG. 4 is a functional block diagram illustrating the interconnection between some of the hardware components and software processes in one embodiment of the present invention.

FIG. 5 is a set diagram illustrating the relationship between the various sets of frequencies that are created and maintained when the present invention is in operation.

FIG. 6 is a flowchart illustrating the process of removing interfered frequencies and how the reallocation process is initiated at the end of the removal process according to one embodiment of the invention.

FIG. 7 is a flowchart illustrating the details of the reallocation process according to one embodiment of the invention. FIG. 7 is divided into FIGS. 7A and 7B for more comfortable viewing.

FIG. 8 is a graph showing how a final group of frequencies is selected as candidates for the reallocation process in one embodiment of the present invention.

FIG. 9 is a graph illustrating the number of allocated frequencies over time when the invention is in operation.

### DETAILED DESCRIPTION OF THE INVENTION

An AFA algorithm ideally relies on frequencies that have low interference from the macro/micro base stations outside the system, even during the busy hours. A frequency can have a low interference level if, for example, the closest cells that use the frequency in the outdoor system have a sufficiently large distance from the indoor system. Low interference on a certain frequency also occurs when the radio signal transmitted by the outdoor system has a large path loss due to the penetration through walls, floors, etc. With the AFA of the present invention, reliance is still confined to very low interference frequencies when it is possible to do so and still meet traffic demand. With the increasing tightening of frequency reuse plans in the surrounding outdoor systems, however, more and more frequencies will be used at closer distances to an indoor system. Depending on the indoor system's radio environment there is an increasing risk of having too few allocated frequencies to handle offered traffic and to maintained channel quality. It is in this increasingly common situation where the AFA of the present invention is highly advantageous. Even in such a situation, where the AFA of the invention allows channels with more than the ideally low level of interference to be used, the AFA still first resorts to reallocating interfered frequencies with the lowest possible interference levels relative to available frequencies in general.

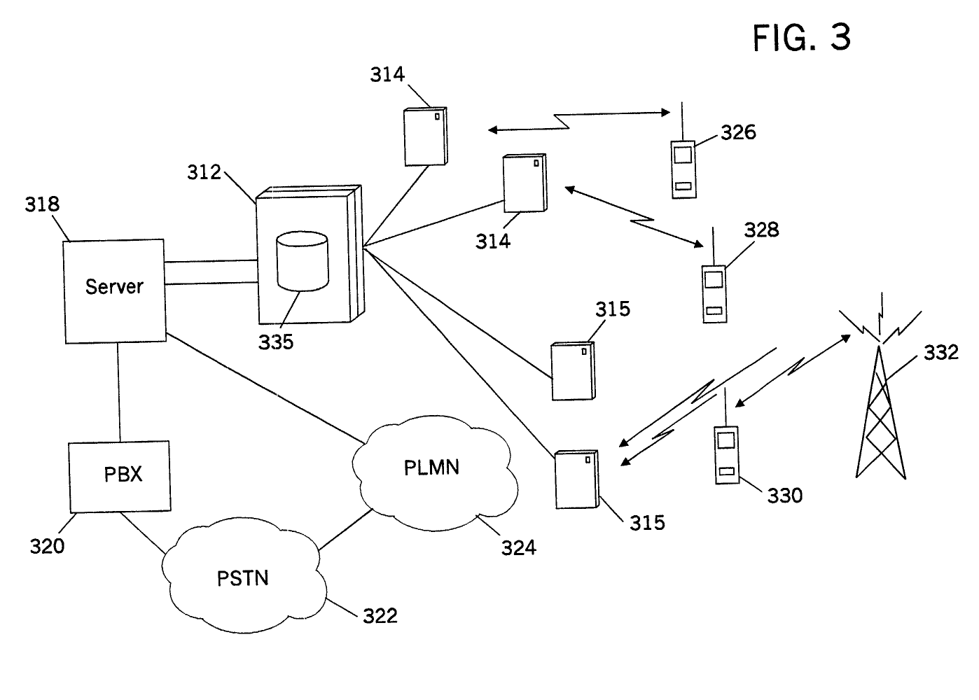

Referring to FIG. 3, a generalized block diagram illustrates a wireless communication system that uses an adaptive frequency allocation (AFA) system and method in accordance with the invention. The communication system shares the frequency spectrum with outdoor or public cellular systems. The communication system includes a radio exchange, 312 connected to a plurality of radio heads or base stations, 314, two of which are shown, and to a plurality of scanners, 315, two of which are shown. A typical small wireless communication system might include as many as thirty-two radio heads and four scanners. Exchange 312 is connected to a mobility server 318, which is in turn connected to private branch exchange (PBX) 320. The PBX 320 receives calls from, and sends calls to, the public switch telephone network (PSTN) 322. The mobility server 318 is also connected to the public land mobile network (PLMN) 324. The mobility server is provisioned with information about the various mobile stations served so that exchange 312 can handle calls in and out of the system appropriately. Thus, exchange 312 controls and coordinates the wireless connections among the plurality of radio heads 314 and various wireless communication devices, represented by mobile stations 326 and 328 and the PSTN 322 or PLMN 324. The mobile stations may also be intended to communicate directly with a cellular public network, as illustrated by the mobile station 330 in communication with a cellular base transceiver station (BTS) 332, which is part of the PLMN 324. The BTS may also be a source of interference.

Usually, numerous radio frequencies are available for use by both the small wireless system shown, and the PLMN, 324. PLMN 324 allocates select frequencies to each BTS, 332. The AFA in accordance with the invention functions to allocate select frequencies to be used as a pooled resource by the small wireless communication system. As a result, plural radio heads 314 can communicate on the same frequencies as those in use by the PLMN at the same time. The logic that implements the AFA is represented within exchange 312 by storage 335.

The radio exchange 312, in accordance with one embodiment of the invention, comprises a programmed processing system. The processing system is conventional in nature and includes a central processing unit, such as a microprocessor or digital signal processor, and associated memory, as is well known and is therefore not specifically shown herein. The AFA function implemented in the processing system collects and filters received signal strength (RSS) measurements taken from the scanners and uses algorithms for making frequency allocation decisions based on these filtered measurements. The algorithm is operated to remove frequencies from and reestablish these frequencies to an allocated frequency set. The allocated frequency set is then used as a pooled resource by transceivers in the radio heads.

The present invention may be embodied one or more systems, methods, apparatus and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system which is part of the communication system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

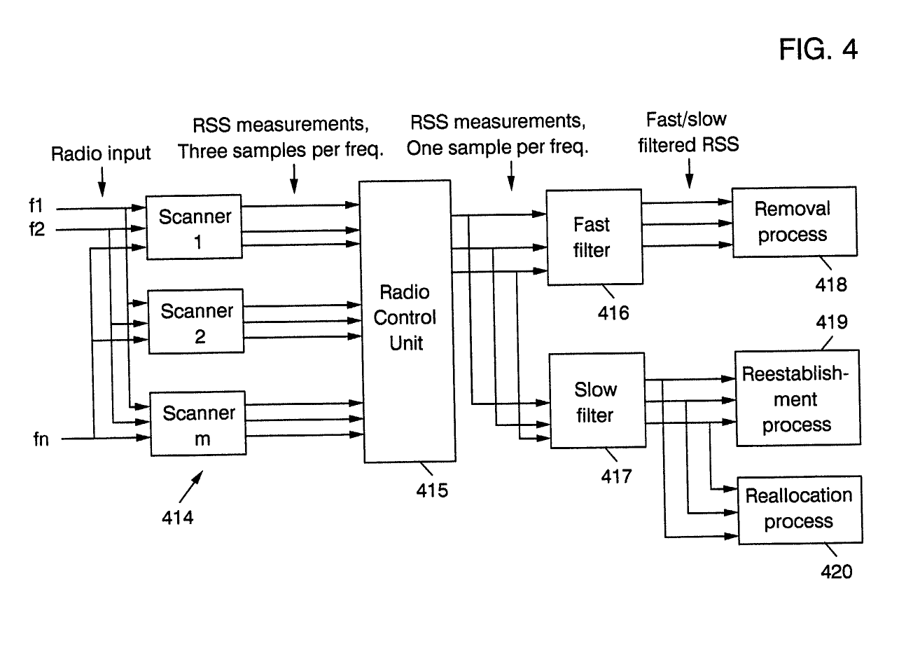

FIG. 4 is a block diagram that illustrates additional detail of the various devices and processes directly involved in implementing the AFA in one embodiment of the invention. Dedicated radio scanners 414 are placed in different locations of the building to periodically measure the RSS of all frequencies, in this example embodiment, scanners 1, 2, through scanner m make measurements on frequencies f1, f2, through fn. The scanners shown in FIG. 4 correspond to scanners 314 shown in FIG. 3. All other structures and processes shown in FIG. 4 are located within the radio exchange in this illustrated embodiment of the invention.

Each scanner in FIG. 4 includes one uplink receiver and two downlink receivers for diversity. Every receiver in a scanner takes one RSS sample per frequency per scanning period so that there are three samples per frequency for every scanning period. The scanner passes the maximum RSS sample per frequency to radio control unit 415 for processing. For each frequency, radio control unit 415 takes the maximum RSS sample out of the RSS samples from the multiple scanners. We call this maximum or highest scanned value the “ISH” for convenience, roughly meaning “interference scan-highest ”. The radio control unit then feeds the ISH sample of each frequency to two low-pass filters to smooth out the random variations of the measured RSS due to fading. Fast filter 416 applies a small time constant to produce a filtered ISH output, called fast low-pass filtered ISH, or “FastLPISH” that reacts quickly to new RSS measurements. Slow filter 417 uses a large time constant to generate filtered RSS output, called slow low-pass filtered ISH or “SlowLPISH” that responds slowly to new RSS measurements. The large time constant is typically on the order of one hour, while the small time constant is typically on the order of forty seconds, although other time constants can be used. ISH values are not updated if a channel has been busy with traffic during a particular sample period.

AFA according to the invention includes three processes. Removal process 418 removes the frequencies from the set of allocated frequencies based on the FastLPISH. Reestablishment process 419 reestablishes frequencies that are currently not allocated based on the SlowLPISH, when there are enough frequencies to meet traffic demand. Finally, the early reestablishment process, called for discussion purposes, the reallocation process, 420, reallocates frequencies with the same time interval as the removal process when there are NOT enough frequencies to meet traffic demand. It should be noted that the term “process” used above in reference to the removal, reestablishment, and reallocation processes refers to any hardware or software that implements the processes described herein, or any combination of hardware and software that implements the processes.

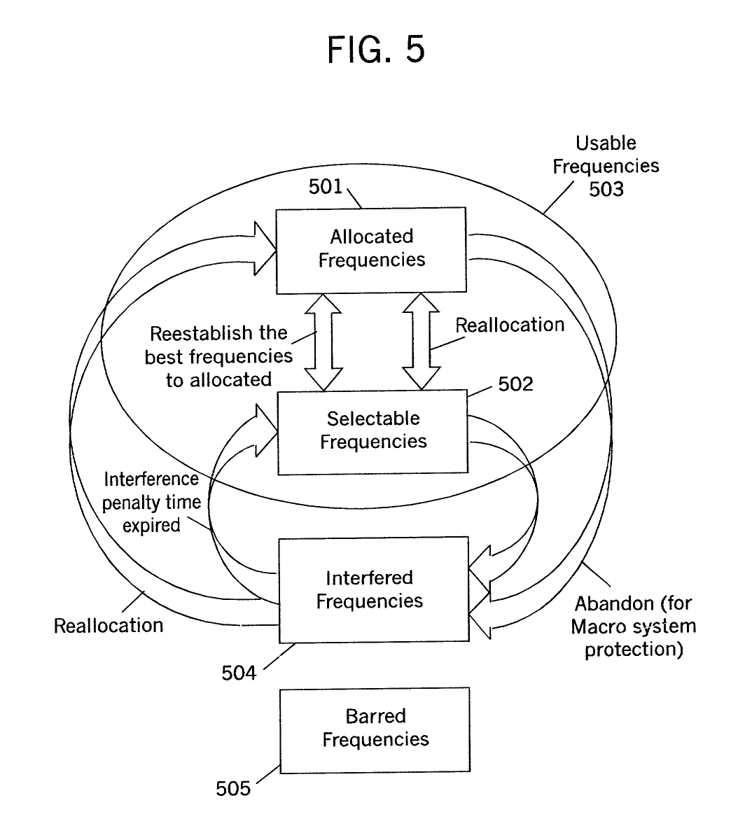

Referring to FIG. 5, a set diagram is presented which illustrates how the invention, in one embodiment, works with a set of allocated frequencies (the “allocated set”), a set of selectable frequencies (the “selectable set”), a set of frequencies which have recently experienced interference (“interfered frequencies” or “interfered set”), and a set of barred frequencies. FIG. 5 describes a high-level grouping of frequencies into “sets” used by the AFA algorithm for all processes, which is not to be confused with terms such as the “proposed group” and “final group” used by the reallocation process, as described in detail later. The allocated set, 501, and the selectable set, 502, together comprise the usable set, 503. The removal process abandons frequencies from the usable set, both the allocated frequencies and selectable frequencies, when interference levels are too high, as shown by the arrows in FIG. 5. These frequencies are moved to the interfered set of frequencies, 504, and eventually, moved back to the selectable set, 502 as penalty times for specific frequencies expire. The reestablishment process reestablishes the best selectable frequencies, 502 into the allocated frequency set, 501. The reaction time to abandon a frequency when interfered is much shorter than the time to reestablish a frequency after interference has ceased, as long as traffic demand can be met with the number of frequencies in the allocated set. Certain frequencies may be designated as barred frequencies, as represented by set 505. Optionally, fixed frequencies can be manually allocated to the allocated frequency set, 501, for control or administrative purposes. These frequencies are non-volatile. The manual frequency allocation is not part of the present invention, and so need not be discussed further. Finally, if the number of allocated frequencies falls below a minimum required to meet traffic demand, a fast, reallocation process takes place to move some frequencies back into allocated set 501 from both the selectable and interfered sets, 502, and 504.

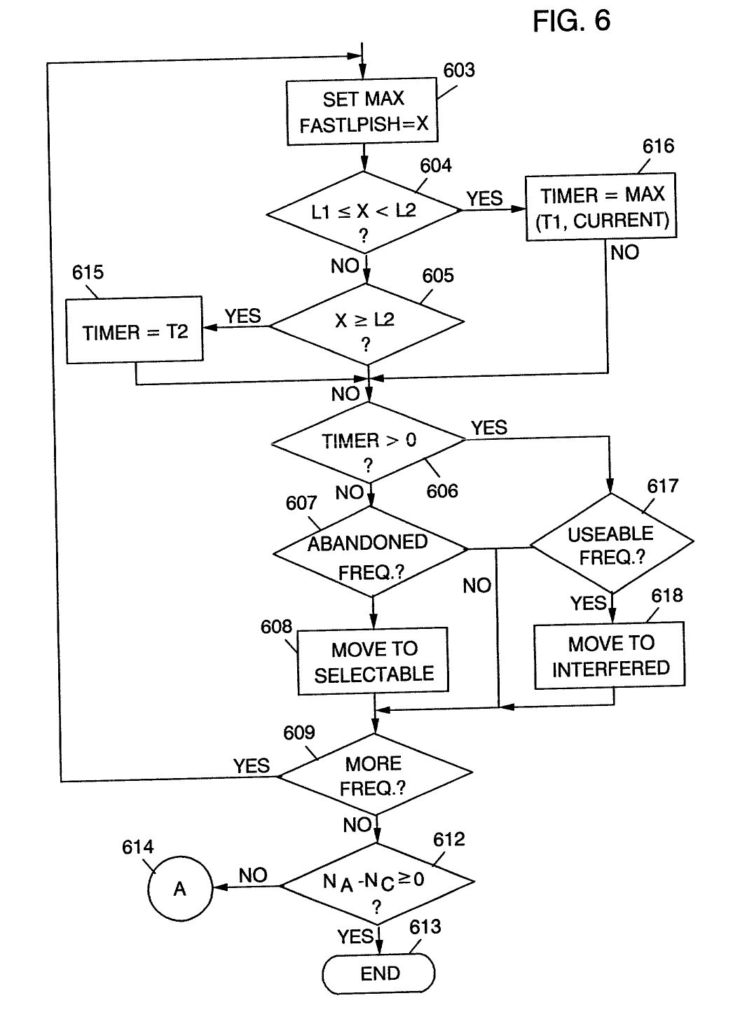

Referring to FIG. 6, a flowchart illustrates a logic sequence implemented in the radio exchange for abandoning idle frequencies and checking for a condition where there are not enough allocated frequencies to handle traffic demand. All blocks in FIG. 6, except for block 612, block 613 and block 614, apply to a particular idle frequency. Initially, block 603 takes the maximum FastLPISH value from all scanners for each idle frequency and stores each value as a variable X. If the value X is greater than or equal to the first threshold L1 and less than the second threshold L2 as determined at step 604, then a timer is set to a maximum of a first time penalty value T1 or the current timer value at a block 616. If the conditions of the decision block 604 are not met, then a decision block 605 determines if the value X is greater than or equal to L2. If so, then the timer is set to the value of a second time penalty value T2 at block 615. If not, indicating that the maximum FastLPISH value is not larger than either threshold, then the timer remains at its current value. Subsequently, a decision block 606 determines if the timer value is greater than 0. If not, then a decision block 607 determines if the particular frequency is presently indicated as an abandoned frequency, that is, in the interfered set. If so, then it is moved to the selectable frequency set at block 608 and the routine moves to decision block 609. If the timer value is greater than 0, as determined at decision block 606, then a decision block 617 determines if the particular frequency is presently a usable frequency. If not, then decision block 609 is invoked. If so, then the frequency is moved to the interfered frequencies at block 618 and then decision block 609 is invoked. As is apparent, if the frequency is not moved to another set then it retains its previous state, but the delay time can be updated.

In accordance with the invention, the first threshold L1 may be on the order of −105 dBm and the second threshold L2 may be on the order of −88 dBm. The first time penalty TI may be on the order of 45 minutes, while the second time penalty T2 may be on the order of 7 hours. These values are illustrated for example only, and the particular values used may be determined according to engineering requirements of the particular system. Also, more or less than two sets of thresholds and time penalty values can be used.

As discussed above, scanner measurements are not used on frequencies that are currently in use in the wireless system that is implementing the invention. Instead, the AFA function indirectly uses the intra-radio head handoff triggered by high bit error rates. On each ongoing call, bit error rate and received signal strength are monitored both on the uplink and the downlink. If the bit error rate exceeds a threshold at the same time that received signal strength is better than another threshold, an intra-radio head handoff is done to the least interfered channel on another frequency in the allocated frequency set. If the call leaves the traffic frequency, then the frequency is idle and measured by the scanners, and will be abandoned if it is still interfered with in accordance with the logic sequence of FIG. 6.

After all idle frequencies have been processed, Decision block 612 checks to see whether or not the number of frequencies in the allocated set has fallen below a minimum number to meet traffic demand. In block 612, N_{A} represents the number of frequencies in the allocated set. N_{C} represents the minimum number needed to meet traffic demand. As long as the condition:

N_{A}−N_{C}≧0

is true, the number of frequencies is sufficient. If, however, this equation is no longer true, processing branches at A, 614 to the reallocation process that tries to increase the number of frequencies allocated on an expedited basis.

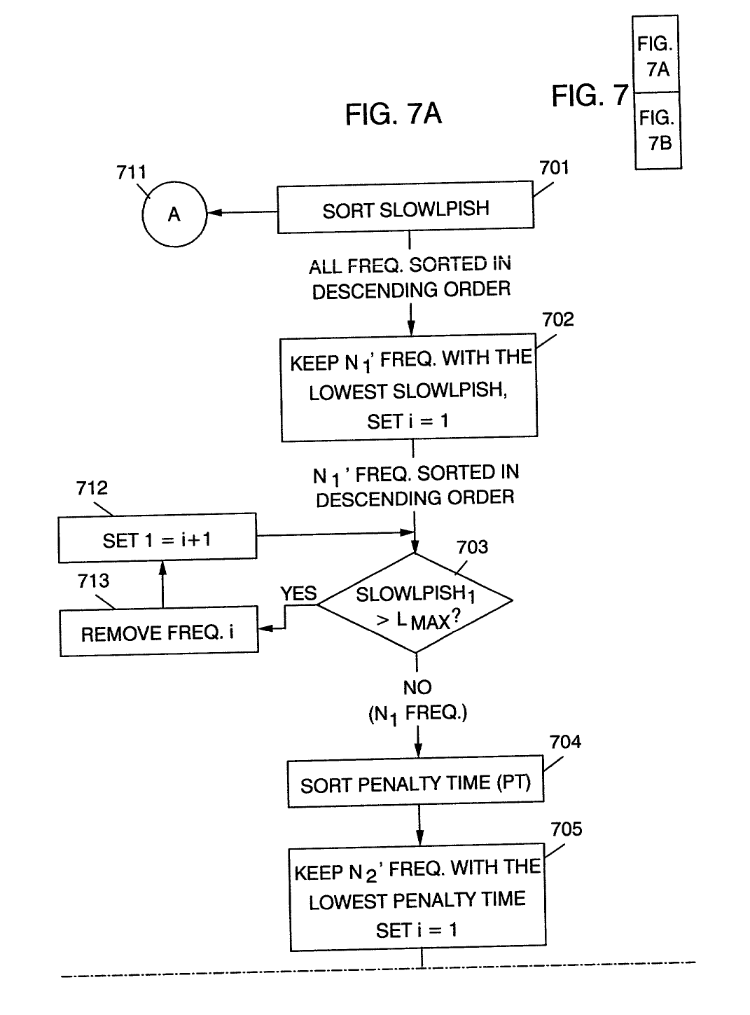

FIG. 7 is a flowchart illustrating the reallocation process according to one embodiment of the invention. FIG. 7 is divided into FIGS. 7A and 7B for more comfortable viewing. The process starts where it branches from the process illustrated in FIG. 6, at point A, 711. At step 701, all frequencies (except barred frequencies) are sorted according to their SlowLPISH values in descending order. A maximum of N₁′ frequencies with the lowest SlowLPISH values are kept, at block 702, as a starting group of candidate frequencies to be reallocated. At decision block 703, the SlowLPISH of each candidate frequency SlowLPISH where i=1,2,3, . . . , etc., is compared to a Lₘₐₓ, a maximum acceptable interference level for the frequency to be used. Lₘₐₓ is a system parameter selected by the system operator. If the interference level as represented by the SlowLPISHᵢ value is larger than this level, the frequency is removed from the candidate group at block 713, and the process moves on to the next candidate frequency by incrementing the frequency index by one at block 712. If the SlowLPISHᵢ is not larger than Lₘₐₓ, at step 703, then the candidate frequency and all subsequent frequencies are kept since the candidate frequencies are sorted in descending order of SlowLPISH. The outcome of block 703 is a proposed group of N₁ Frequencies. The N₁ frequencies are sorted based on their current residual penalty time at step 704, and a maximum of N₂′ frequencies are retained at block 705 as an intermediate group of frequencies having the lowest, current residual penalty times. Also at this step, the frequency index is initialized to 1. The penalty time, PTᵢ for each frequency, i =1, 2, 3, . . . , etc., is then compared to an absolute maximum allowed penalty time, Tₘₐₓ, at decision block 706. Tₘₐₓ is a system parameter selected by the system operator. Frequencies whose penalty times are above this value are removed at block 715 and the process moves on to the next frequency by incrementing the frequency index by one at block 714. The outcome of block 706 is N₂ frequencies that are the candidates of reallocation. Frequency index is initialized to 1 (block 707), and for each of the reallocation candidates, a check is made at step 708 to determine whether or not the current frequency is already in the allocated set of frequencies. If not, the frequency is added to the allocated set (717), the current residual penalty time is set to 0 and frequency index is incremented by one (716). If the check at decision block 708 indicates that the frequency is already in the allocated set, then the processing moves to block 709 where it is determined whether or not all N₂ frequencies have been checked. If not, the frequency index is incremented by one (718) and the decision step in block 708 is repeated. If all N₂ frequencies have been considered, then the processing ends at 719.

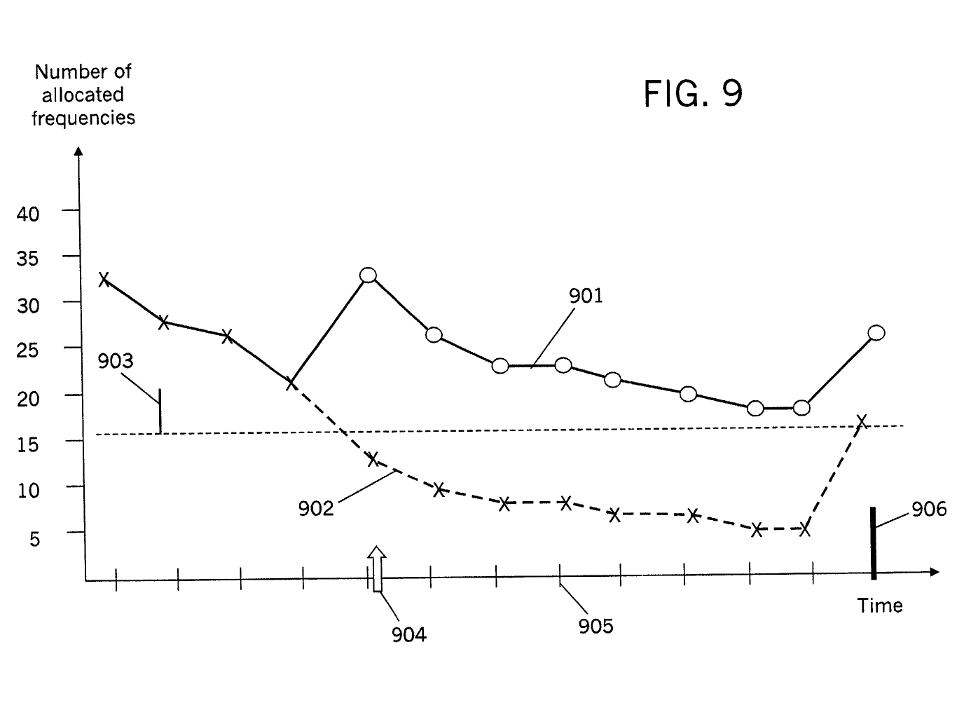

Note that, as shown in FIG. 9 (discussed below), if the number of frequencies in the allocated set never falls below the minimum, frequencies are eventually moved into the selectable set as timers expire. Periodically then, at a time referred to as time to reestablish, the least interfered frequencies are reestablished to the allocated frequencies. This time to reestablish may be on the order of thirty minutes. When it is time to reestablish normally, the usable frequencies, i.e., the allocated and selectable frequencies are sorted based on the SlowLPISH values and compared to another interference threshold selected by the system operator. Allocated frequencies with an interference value lower than the threshold are considered good enough and are not replaced. This reduces unnecessary system response due to small changes in external interference. If the interference value is greater than the threshold, then a determination is made as to whether there are sufficiently better frequencies found among the selectable frequencies. This algorithm uses hysteresis to avoid replacing allocated frequencies with marginally better selectable frequencies. Frequencies in the allocated frequency set may be swapped out for better frequencies, which could result in forced intra-radio-head handoffs. The number of frequencies swapped out on a single evaluation may optionally be limited by another system parameter. If there is a better selectable frequency, then the frequencies are swapped. Further details on this normal reestablishment process can be found in the previously referenced, prior patent application.

A system owner or operator can “fine-tune” AFA behavior in many ways. The L1 and L2 interference levels referred to in FIG. 6 can be adjusted. Also, the minimum number of frequencies needed to meet demand, N_{C} in FIG. 6, can be adjusted either manually or through an automated demand-monitoring algorithm. The maximum allowed interference level and maximum penalty time referred to in FIG. 7 can be adjusted for the particular application of the small wireless system. If longer penalty time frequencies are reallocated, these frequencies experienced interference more recently, and may be more likely to experience it again. If higher interference level frequencies are reallocated, there is a greater likelihood of high bit error rates on a reallocated frequency. Finally, the interference threshold for swapping frequencies in the normal reestablishment process can be adjusted. It should be noted that if traffic demand does not warrant the early reallocation procedure described in FIG. 7, the AFA automatically proceeds with normal removal and reestablishment, and the lowest possible interference levels, and thus the highest possible quality of communication is maintained.

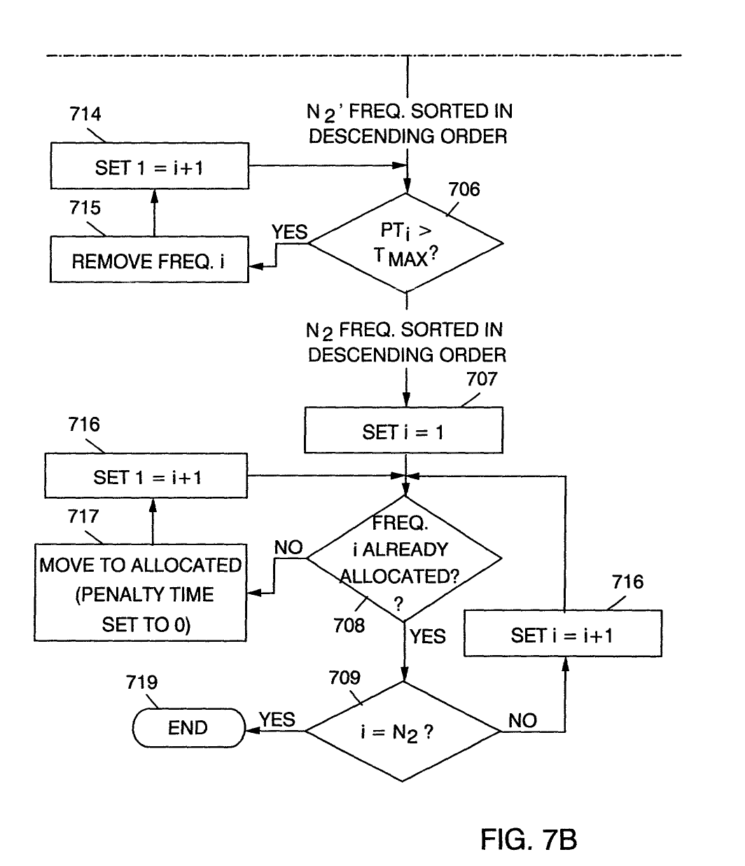

FIG. 8 graphically illustrates the reallocation algorithm's affects on individual frequencies, and helps to visualize what happens to those frequencies. The graph represents the state of frequencies right before frequencies in the final group are reallocated. The horizontal axis represents penalty time, going short to long from left to right, and vertical axis 801 represents interference level, going low to high from the bottom up. Frequencies along the vertical axis have zero penalty time, and are in the usable set. Frequencies represented by an unfilled point, like that shown at 802, are selectable frequencies, that is they have just reached zero penalty time and would be reestablished at the next regular time to reestablish if the reallocation algorithm were not invoked. Frequencies represented by filled points like that shown at 803 are currently in the allocated set. All other frequencies are in the interfered set.

The final group of frequencies in FIG. 8 includes the usable frequencies already discussed, as well as interfered frequencies like frequency 804 that is presently in the interfered set, but also in the final group of frequencies chosen by the reallocation algorithm of FIG. 7. The algorithm of FIG. 7 will reallocate such interfered frequencies. Interfered frequencies such as frequency 805 will be kept in the interfered set because its penalty time is too high, being longer than Tₘₐₓ. Frequencies such as frequency 806 will be kept in the interfered set because its interference level is too high, being above Lₘₐₓ. Finally, frequencies such as frequency 807 will be kept in the interfered set because both its interference level as measured by SlowLPISH is too high and its penalty time PT is too long.

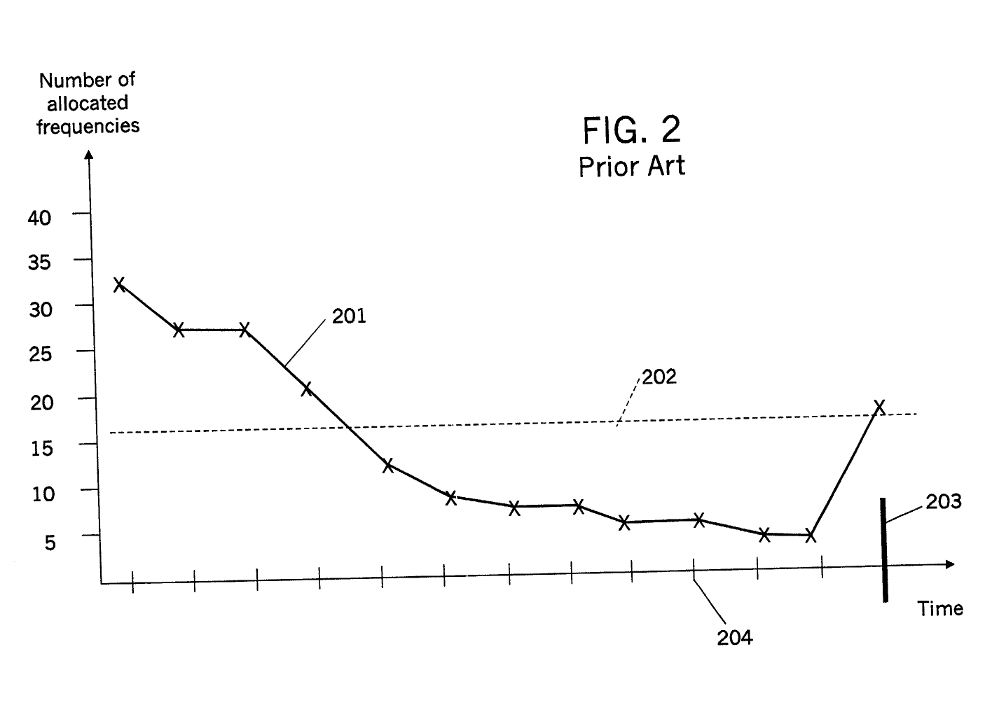

FIG. 9 graphically illustrates the effect of invoking the reallocation algorithm with the same interference situation as was shown in FIG. 2. In FIG. 9, on the fifth normal removal process, 904, the number of allocated frequencies, shown by trace 901 drops below the critical level, 903 (N_{C}=15 in this example). During the fifth removal process, since the number of allocated frequencies drops below 15, the new reallocation process causes early reestablishment of frequencies. In the subsequent removal processes, the size of the allocated set never drops below 15. Finally the normal reestablishment process 906 increases the size of the allocated set by another 10 frequencies. Using the AFA of the invention, the system is able to maintain at least 15 frequencies at all times within the reestablishment period. In contrast, the size of the allocated set drops below 15 for most of the time within a reestablishment period if the reallocation process is not invoked, as shown by curve 902, displayed here for convenience.

The description of the AFA has until now focused on traffic channels. However, in some small wireless communication systems, other frequencies are used for digital control channels (DCCH). The radio exchange has no valid measurements for DCC frequencies because a DCCH frequency is always busy. Therefore, the radio exchange rotates the serving DCCH among a number of frequencies, referred to as DCCH candidates. This allows the scanners to measure all frequencies on a more equal basis. The DCCH candidates are always part of the allocated frequency set. This DCCH handling is not part of the present invention and details on how it is accomplished can be found in the referenced prior patent application.

Note that, with the AFA of the invention, the risk of having too few allocated frequencies is minimized because once the size of the allocated set drops below a critical level the proposed reallocation process is executed with very short reaction time. If the size of the allocated set never drops below the critical level, the AFA of the invention behaves in exactly the same way as the old AFA, ensuring the interference is minimized to the greatest extent possible in the small wireless system. With the invention, the frequencies are much better utilized when they are mostly needed, i.e. when the number of allocated frequencies is potentially too low to handle the offered traffic. Without the invention, frequencies could not be used as long as their penalty time has not reached zero, even when they have low interference. The selection of the frequencies to be added with the reallocation process is the optimum in the sense that the selected frequencies have the lowest interference levels available as well as the lowest residual penalty times available.

I have described herein specific embodiments of an invention. One of ordinary skill in the networking and computing arts will quickly recognize that the invention has other applications in other environments. In fact, many embodiments and implementations are possible. The following claims are in no way intended to limit the scope of the invention to the specific embodiments described.

I claim:

1. A method of automatically reallocating previously removed frequencies to be used as allocated frequencies in order to maintain traffic capacity in a wireless communication system operable for automatic frequency allocation wherein each removed frequency has an associated penalty time and interference level, the method comprising:
determining if a number of allocated frequencies is less than a minimum number of allocated frequencies required to maintain traffic capacity;
selecting a proposed group of frequencies having the lowest acceptable interference levels if the number of allocated frequencies is less than the minimum number;
selecting a final group of frequencies from the proposed group of frequencies by placing in the final group, the frequencies from the proposed group that have the shortest acceptable penalty times; and
reallocating frequencies in the final group of frequencies.

2. The method of claim 1 wherein selecting the proposed group of frequencies having the lowest acceptable interference levels from among available frequencies further comprises:
selecting a starting group of frequencies having the lowest interference levels; and
selecting the proposed group of frequencies from the starting group of frequencies, wherein each frequency in the proposed group of frequencies has an interference level below a maximum acceptable interference level.

3. The method of claim 1 wherein selecting the final group of frequencies from the proposed group of frequencies by placing in the final group, the frequencies from the proposed group that have the shortest acceptable penalty time further comprises:
selecting an intermediate group of frequencies from the proposed group of frequencies by placing in the intermediate group, the frequencies from the proposed group that have the shortest penalty time; and
selecting the final group of frequencies from the intermediate group of frequencies, wherein each frequency in the final group of frequencies has a current penalty time below a maximum acceptable penalty time.

4. The method of claim 2 wherein selecting the final group of frequencies from the proposed group of frequencies by placing in the final group, the frequencies from the proposed group that have the shortest acceptable penalty time further comprises:
selecting an intermediate group of frequencies from the proposed group of frequencies by placing in the intermediate group, the frequencies from the proposed group that have the shortest penalty time; and
selecting the final group of frequencies from the intermediate group of frequencies, wherein each frequency in the final group of frequencies has a current penalty time below a maximum acceptable penalty time.

5. Apparatus for automatically reallocating previously removed frequencies to be used as allocated frequencies in order to maintain traffic capacity in a wireless communication system operable for automatic frequency allocation wherein each removed frequency has an associated penalty time and interference level, the apparatus comprising:
means for determining if a number of allocated frequencies is less than a minimum number of allocated frequencies required to maintain traffic capacity;
means for selecting a proposed group of frequencies having the lowest acceptable interference levels;
means for choosing a final group of frequencies from the proposed group of frequencies by placing in the final group, the frequencies from the proposed group that have the shortest acceptable penalty times; and
means for reallocating frequencies in the final group of frequencies to be used as allocated frequencies.

6. A programmed radio exchange operable for automatic frequency allocation wherein a frequency with an interference level is removed for an associated penalty time from an allocated set of frequencies when interference is detected on the frequency, the exchange further being enabled by a computer program to automatically reallocate previously removed frequencies to be used as allocated frequencies in order to maintain traffic capacity, the computer program comprising:
program code for determining if a number of allocated frequencies is less
than a minimum number of allocated frequencies required to maintain traffic capacity;
program code for selecting a proposed group of frequencies having the lowest acceptable interference levels;
program code for choosing a final group of frequencies from the proposed group of frequencies by placing in the final group, the frequencies from the proposed group that have the shortest acceptable penalty time; and
program code for reallocating frequencies in the final group of frequencies to be used as allocated frequencies.

7. The programmed radio exchange of claim 6 wherein the selecting of the proposed group of frequencies is accomplished by sorting available frequencies according to interference level and selecting only those frequencies which have both lowest interference levels and interference levels below a maximum acceptable interference level.

8. The programmed radio exchange of claim 6 wherein the selecting of the final group of frequencies is accomplished by sorting available frequencies according to current penalty time and selecting only those frequencies which have both lowest penalty times and penalty times below a maximum acceptable penalty time.

9. The programmed radio exchange of claim 7 wherein the selecting of the final group of frequencies is accomplished by sorting available frequencies according to current penalty time and selecting only those frequencies which have both lowest penalty times and penalty times below a maximum acceptable penalty time.

10. A computer program product for enabling a radio exchange to automatically reallocate previously removed frequencies, each having an interference level and a penalty time, to be used as allocated frequencies in order to maintain traffic capacity, the computer program product comprising a computer program further comprising:
instructions for determining if a number of allocated frequencies is less than a minimum number of allocated frequencies required to maintain traffic capacity;
instructions for selecting a proposed group of frequencies having the lowest acceptable interference levels;
instructions for choosing a final group of frequencies from the proposed group of frequencies by placing in the final group, the frequencies from the proposed group that have the shortest acceptable penalty time; and
instructions for reallocating frequencies in the final group of frequencies to be used as allocated frequencies.

11. The computer program product of claim 10 wherein instructions for selecting of the proposed group of frequencies further comprises:
instructions for sorting available frequencies according to interference level and selecting only those frequencies which have lowest interference levels; and
instructions for selecting frequencies that have interference levels below a maximum acceptable interference level.

12. The computer program product of claim 10 wherein the instructions for selecting the final group of frequencies further comprises:
instructions for sorting frequencies in the proposed group of frequencies according to current penalty time and selecting only those frequencies which have lowest penalty times; and
instructions for selecting frequencies which have penalty times below a maximum acceptable penalty time.

13. The computer program product of claim 11 wherein the instructions for selecting the final group of frequencies further comprises:
instructions for sorting frequencies in the proposed group of frequencies according to current penalty time and selecting only those frequencies which have lowest penalty times; and
instructions for selecting frequencies which have penalty times below a maximum acceptable penalty time.

14. A wireless communication system enabled for automatic frequency allocation comprising:
at least one transceiver;
at least one scanner for measuring received signal strength (RSS) on one or more frequencies; and
a radio exchange system connected to the scanner and the transceiver, the radio exchange system further comprising a radio control unit operable to derive an interference sample for each frequency measured by the scanner and execute a reallocation process that determines if a number of allocated frequencies is less than a minimum number of allocated frequencies required to maintain traffic capacity and reallocates frequencies based on current penalty times and interference levels if and when the number of allocated frequencies is less than the minimum number.

15. The wireless communication system of claim 14 wherein the radio exchange system further comprises a slow low pass filter disposed between the radio control unit and the reallocation process so that the interference levels are based on slow filtered RSS samples.
